(19) United States
(12) Patent Application Publication
(10) Pub. No.: US 2026/0257729 A1
(43) Pub. Date: Sep. 3, 2026

(54) VEHICLE SIDE STRUCTURE

(71) Applicant: Nissan Motor Co., Ltd., Kanagawa (JP)

(72) Inventor: Tomoyuki Sone, Kanagawa (JP)

(73) Assignee: Nissan Motor Co., Ltd., Kanagawa (JP)

(21) Appl. No.: 18/878,320

(22) PCT Filed: Jun. 28, 2022
(86) PCT No.: PCT/JP2022/025653

§ 371 Date: Dec. 23, 2024

(51) Int. Cl. B62D 25/04

(52) U.S. Cl. CPC B62D 25/04

(57) ABSTRACT

A vehicle side structure includes a dash panel of a vehicle V and a front pillar joined to the dash panel on an outer side in a vehicle width direction. The front pillar includes an outer member forming an outer side of the front pillar in the vehicle width direction. At least a part of a first flange formed on a front side of the outer member in a vehicle longitudinal direction is bent toward an inner side in the vehicle width direction to form the first joint joined to the dash panel.

### TECHNICAL FIELD

The present invention relates to a vehicle side structure.

### BACKGROUND ART

In a front pillar lower structure disclosed in Patent Literature 1 listed below, a coupling unit is formed integrally with a hinge reinforcement arranged on an inner side of a front pillar outer part in a vehicle width direction. The coupling unit joins a part connecting an overlapped portion of a front pillar inner panel and an upper flange of a rocker inner front end with an outer wall of the front pillar outer part in the vehicle width direction.

### CITATION LIST

### Patent Literature

Patent Literature 1: JP 2011-136593 A

### SUMMARY OF INVENTION

### Technical Problem

However, in a front pillar formed by joining an inner member and an outer member by a flange, a dimension of a cross section of the front pillar in a vehicle longitudinal direction is set to secure the rigidity of the front pillar. Therefore, for example, if a front door and a front wheel are arranged closer to each other, positions of the front door and the front wheel may be restricted by a width of the front pillar in the vehicle longitudinal direction. Further, if a width of the front pillar in the vehicle longitudinal direction is reduced so as to enable positions of the front door or the front wheel to be set more freely, the dimension of the cross section of the front pillar in the vehicle longitudinal direction is reduced, and there is a risk that the rigidity of the front pillar cannot be sufficiently secured.

An object of the present invention is to provide a vehicle side structure capable of sufficiently securing rigidity of a front pillar without excessively increasing a width of the front pillar in a vehicle longitudinal direction.

### Technical Solution

A vehicle side structure according to an aspect of the present invention includes a dash panel of a vehicle and a front pillar joined to the dash panel, wherein the front pillar includes an outer member, and at least a portion of a first flange of the outer member is bent toward the inner side in a vehicle width direction to form a first joint joined to the dash panel.

### Advantageous Effects

According to the present invention, it is possible to provide a vehicle side structure capable of sufficiently securing the rigidity of a front pillar without excessively increasing a width of the front pillar in a vehicle longitudinal direction.

### BRIEF DESCRIPTION OF DRAWINGS

FIG. 1 is a side view illustrating a positional relationship between a front pillar and a front wheel in a vehicle side structure according to an embodiment.

FIG. 2 is a perspective view for explaining an arrangement relationship between a dash panel and a front pillar in a vehicle side structure according to an embodiment.

FIG. 3 is a perspective view for explaining an arrangement relationship between a dash panel, an outer member, and an inner member in a vehicle side structure according to an embodiment.

FIG. 4 is a cross-sectional view taken along line IV-IV in FIG. 1 for explaining an arrangement relationship between a front wheel, a dash panel, an outer member, and an inner member in a vehicle side structure according to an embodiment.

### DESCRIPTION OF EMBODIMENTS

A vehicle side structure according to an embodiment will be described below with reference to the drawings. In the drawings, FR and RR denote a front side and a rear side in a vehicle longitudinal direction. LH and RH denote a left side and a right side in a vehicle width direction. Further, UP and DN denote an upper side and a lower side in a vehicle vertical direction. A center side of a vehicle in the vehicle width direction is referred to as an inner side in the vehicle width direction, and a side opposite to the inner side in the vehicle width direction is referred to as an outer side in the vehicle width direction. In the drawings, an inner side in the vehicle width direction is denoted by IS, and an outer side in the vehicle width direction is denoted by OS. In the following description, a front side and a rear side in the vehicle longitudinal direction, a left side and a right side in the vehicle width direction, an upper side and a lower side in the vehicle vertical direction are simply referred to as “a vehicle front side” “a vehicle rear side,” “a vehicle left side” “a vehicle right side,” “an upper side,” and “a lower side,” respectively. In the examples illustrated in the drawings, a vehicle left side corresponds to an outer side in the vehicle width direction, and a vehicle right side corresponds to an inner side in the vehicle width direction. Elements having the same function are denoted by the same reference signs, and duplicate descriptions are omitted.

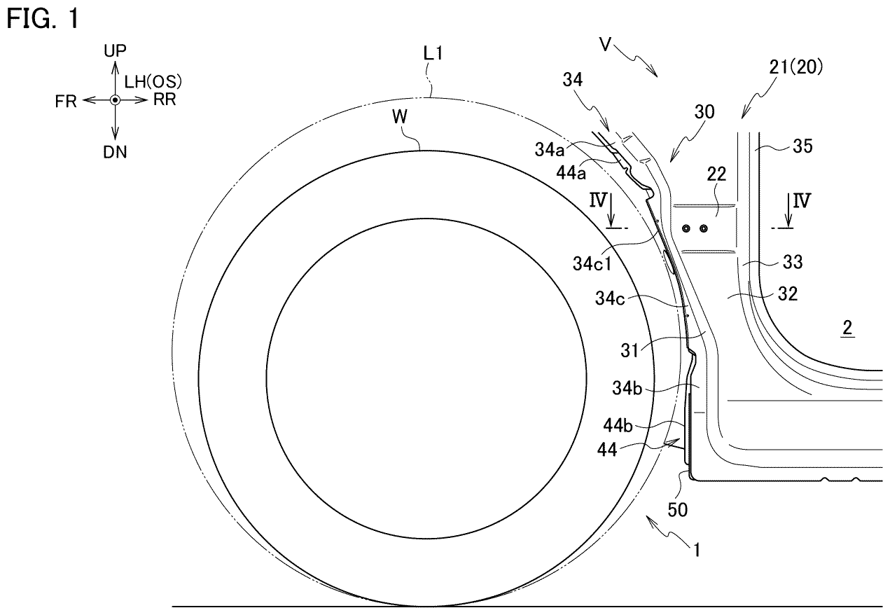

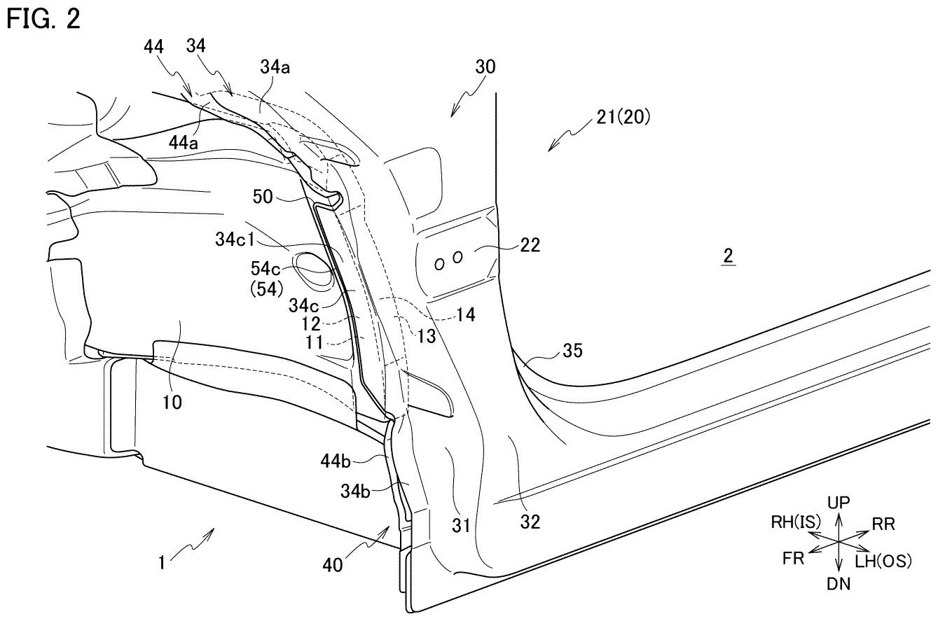

The vehicle side structure according to the embodiment can be applied to a side structure of a vehicle V illustrated in FIG. 1. The vehicle V may be an automobile driven by an internal combustion engine (not illustrated), an electric motor (not illustrated), or the like. As illustrated in FIG. 2, the side structure of the vehicle V includes a dash panel 10 and a front pillar 20.

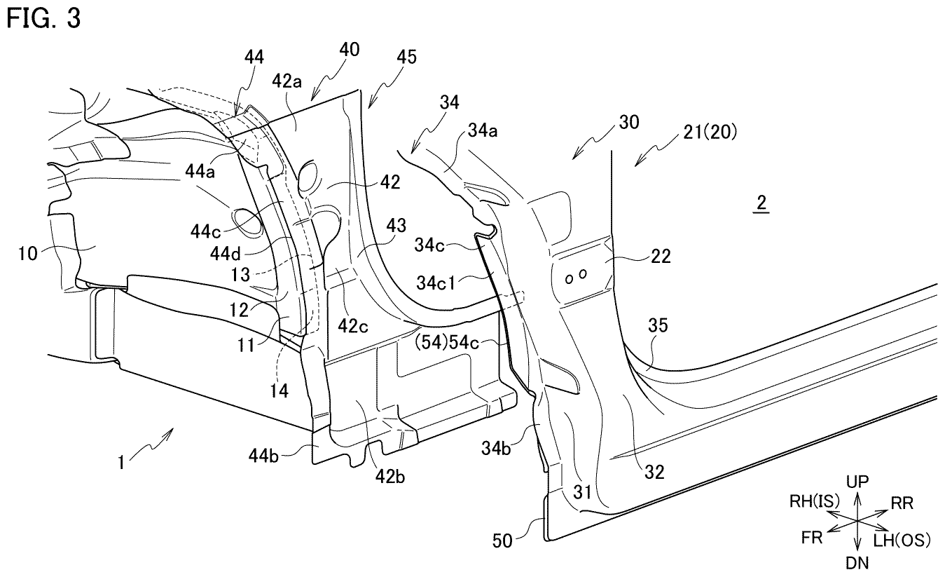

The dash panel 10 illustrated in FIGS. 2 and 3 is a wall member that partitions an engine room, a motor room, or the like, of the vehicle V and a cabin. A wheel house 1 may be provided on a lateral portion 11 of the dash panel 10 on a vehicle front side. The lateral portion 11 forms an outer side of the dash panel 10 in the vehicle width direction, and extends within a predetermined range from an outer end of the dash panel 10 in the vehicle width direction toward a center in the vehicle width direction. As illustrated in FIG. 3, a surface of the lateral portion 11 on the vehicle front side may have a shape curved from a lower side to an upper side so as to protrude toward an upper rear side of the vehicle. The wheel house 1 forms a space in which a front wheel W of the vehicle V is arranged, and may be defined by the lateral portion 11 on the vehicle rear side thereof. That is, the dash panel 10 may define a rear side of the wheel house 1 of the vehicle Vin the vehicle longitudinal direction.

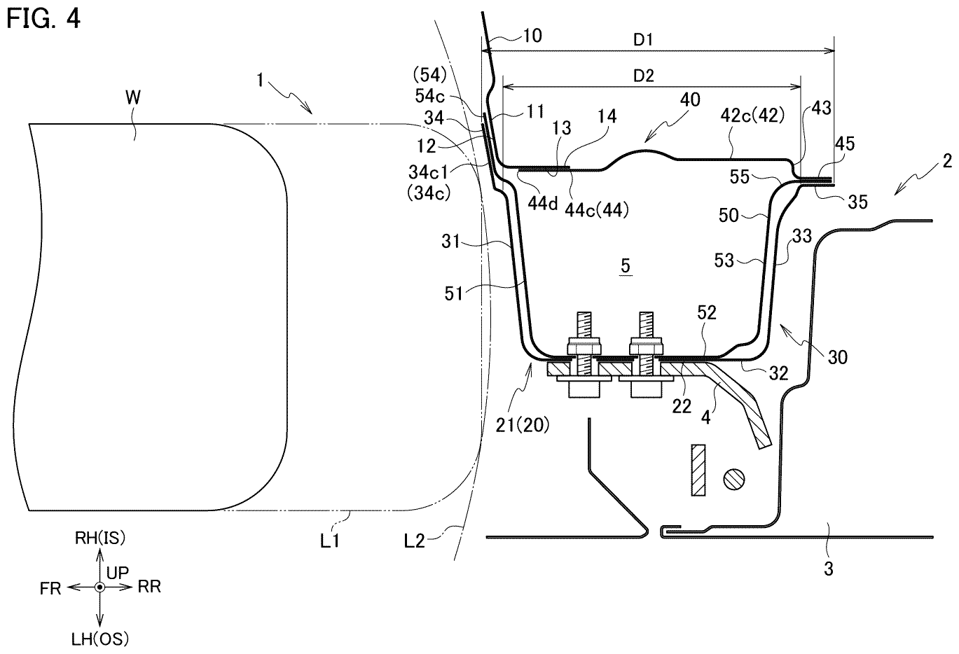

A front pillar 20 is a member for supporting a roof (not illustrated) of the vehicle V on the vehicle front side, and extends in the vertical direction on an outer side of the vehicle V in the vehicle width direction. The front pillar 20 may be joined to the dash panel 10 on an outer side in the vehicle width direction, for example, using welding, or other means. The front pillar 20 defines at least a part of a front door opening 2 on the vehicle front side, and at least a part of the front door opening 2 on the lower side. The front door opening 2 is an opening closed by a front door 3 (see FIG. 4) of the vehicle V. A lower pillar portion 21, which is a portion of the front pillar 20 on the lower side, is positioned outside the lateral portion 11 of the dash panel 10 in the vehicle width direction, and defines the wheel house 1 on the vehicle rear side together with the lateral portion 11.

As illustrated in FIGS. 1 to 4, the front pillar 20 may be provided with a hinge attachment part 22. A door hinge 4 (see FIG. 4) for rotatably supporting the front door 3 within a predetermined angular range can be attached to the hinge attachment part 22. As a result, the front pillar 20 supports the front door 3 via the door hinge 4. In the illustrated example, the hinge attachment part 22 is a part of the front pillar 20 on the outer side in the vehicle width direction and is provided between the wheel house 1 and the front door opening 2. In FIG. 1, the front door 3 and the door hinge 4 are not illustrated.

When the vehicle V travels, the front wheel W is displaced within the wheel house 1 due to, for example, acceleration, deceleration, steering, road conditions, or the like. Chain lines L1 and L2 illustrated in FIGS. 1 and 4 schematically indicate the boundaries of the range in which the front wheel W can be displaced. For example, the chain line L1 in FIG. 1 indicates a range in the vehicle longitudinal direction or the vertical direction in which the front wheel W can be displaced. The chain line L2 in FIG. 4 indicates a range in the vehicle width direction or the vehicle longitudinal direction in which the front wheel W can be displaced.

Next, an example of a structure of the front pillar 20 will be described.

As illustrated in FIGS. 2 to 4, the front pillar 20 may be formed by joining an outer member 30 and an inner member 40 to each other in the vehicle width direction. Further, the front pillar 20 may include a space formed between the outer member 30 and the inner member 40. The structure of the front pillar 20 is not limited to the illustrated example. For example, the front pillar 20 may be configured by forming a side wall extending toward the vehicle rear side at an end of the dash panel 10 on the outer side in the vehicle width direction, and joining a front flange 34 and a rear flange 35 of the outer member 30 to the side wall. In this case, the front pillar 20 may not include the inner member 40.

The outer member 30 is a panel member forming an outer side of the front pillar 20 in the vehicle width direction. In the lower pillar portion 21 illustrated in the drawing, the outer member 30 as a whole has a substantially hat-shaped cross section that opens toward the inner side in the vehicle width direction. Further, the outer member 30 may include a front wall 31, a side wall 32, and a rear wall 33. The front wall 31 is a wall forming a portion of the outer member 30 on the vehicle front side. The side wall 32 is a wall forming a portion of the outer member 30 on the outer side in the vehicle width direction. The rear wall 33 is a wall forming a portion of the outer member 30 on the vehicle rear side.

A front flange 34 is formed as a first flange on the inner side of the front wall 31 in the vehicle width direction, and extends in the vertical direction. That is, a first flange is formed on the outer member 30 on the vehicle front side. The front flange 34 is a joint for directly or indirectly fixing the outer member 30 to the dash panel 10. The front flange 34 is formed to extend in a predetermined direction from an end of the front wall 31 of the outer member 30 on the inner side in the vehicle width direction, and may include a flange 34a, a flange 34b, and a flange 34c as in the illustrated example.

The flange 34a forms a portion of the front flange 34 on the upper side. The flange 34a may be formed to extend from an end of the front wall 31 on the inner side in the vehicle width direction toward the vehicle front side. The flange 34b forms a portion of the front flange 34 on the lower side. The flange 34b may be formed to extend from an end of the front wall 31 on the inner side in the vehicle width direction toward the vehicle front side. The flange 34c forms a portion of the front flange 34 between the flange 34a and the flange 34b. The flange 34c is a flange extending toward the inner side in the vehicle width direction from an end of the front wall 31 on the inner side in the vehicle width direction, and is formed by bending a portion of the front flange 34 toward the inner side in the vehicle width direction. The flange 34c forms a first joint to be joined to the dash panel 10 using welding or other means.

As illustrated in FIG. 1, in a side view, the flange 34c may include a portion 34c1. The portion 34c1 is a portion of the flange 34c equal in height in the vertical direction to a region in which the hinge attachment part 22 is provided. That is, the first joint may include a portion 34c1 of the outer member 30 equal in height in the vertical direction to the hinge attachment part 22.

A rear flange 35, which is a joint for directly or indirectly fixing the outer member 30 to the dash panel 10, may be formed on the inner side of the rear wall 33 in the vehicle width direction so as to extend in the vertical direction. As illustrated in FIG. 4, the rear flange 35 is formed to extend from the inner end of the rear wall 33 in the vehicle width direction toward the vehicle rear side. The rear flange 35 may extend along a portion of the front pillar 20 defining the front door opening 2 on the vehicle front side.

The inner member 40 is a panel member forming an inner side of the front pillar 20 in the vehicle width direction. In the lower pillar portion 21 illustrated in FIGS. 2 to 4, the inner member 40 includes a side wall 42 and a rear wall 43. The side wall 42 forms a portion of the inner member 40 on the inner side in the vehicle width direction. The rear wall 43 forms a portion of the inner member 40 on the vehicle rear side.

A front flange 44 as a second flange is formed on a portion of the inner member 40 on the vehicle front side so as to extend vertically. The front flange 44 is a joint that is joined directly or indirectly to the front flange 34 or the dash panel 10 of the outer member 30. The front flange 44 may include a flange 44a, a flange 44b, and a flange 44c (see FIG. 3). The flange 44c may also form a second joint that will be described later.

The flange 44a forms a portion of the front flange 44 on an upper side. In the same manner as the inner member 40 illustrated in FIG. 3, the flange 44a may be formed by extending a region of an upper portion 42a, which forms a portion of the side wall 42 on the upper side, on the vehicle front side toward the vehicle front side. The flange 44b forms a portion of the front flange 44 on the lower side. The flange 44b is formed to be located on the outer side of the lower portion 42b, which forms a portion of the side wall 42 on the lower side, in the vehicle width direction. The flange 44c forms a portion of the front flange 44 between the flange 44a and the flange 44b. The flange 44c may be formed by extending a region of the middle portion 42c on the vehicle front side, which extends between the upper portion 42a and the lower portion 42b of the side wall 42, toward the vehicle front side.

A rear flange 45 directly or indirectly joined to the rear flange 35 of the outer member 30 may be formed on an outer side of the rear wall 43 in the vehicle width direction. The rear flange 45 illustrated in FIGS. 3 and 4 is formed to extend toward the vehicle rear side from an outer end of the rear wall 43 in the vehicle width direction. The rear flange 45 may extend along a portion of the front pillar 20 defining the front door opening 2 on the vehicle front side.

Next, joining of the dash panel 10, the outer member 30, and the inner member 40 will be described with reference to FIGS. 3 and 4.

In the illustrated example, a surface of the inner member 40 on the inner side in the vehicle width direction is joined to a surface of the lateral portion 11 of the dash panel 10 on the outer side in the vehicle width direction using welding or other means. Here, the flange 44c of the inner member 40 may form a second joint. The second joint is a joint in which an edge of the front flange 44 on the vehicle front side is arranged on the vehicle rear side of the first joint of the outer member 30. That is, an edge 44d of the flange 44c may be positioned on the vehicle rear side of the surface on the front side of the lateral portion 11. The edge 44d is a portion forming an edge of the flange 44c on the vehicle front side. As illustrated in FIG. 4, the surface of the flange 44c on the inner side in the vehicle width direction may be joined to the surface of the lateral portion 11 on the outer side in the vehicle width direction. By forming the flange 44c in this manner, it is possible to prevent the flange 44c from extending to the vehicle front side relative to the surface of the lateral portion 11 on the vehicle front side in the vehicle longitudinal direction.

Joining of the outer member 30 and the inner member 40 illustrated in the drawings may be performed at least by joining the front flange 34 and the front flange 44, and by joining the rear flange 35 and the rear flange 45. More specifically, joining of the front flange 34 and the front flange 44 may be performed by joining the flange 34a and the flange 44a, and by joining the flange 34b and the flange 44b. Further, as illustrated in FIG. 4, the flange 34c of the outer member 30 may be joined to a region 12 as a first region of the dash panel 10 using welding or other means without interposing the front flange 44 of the inner member 40. The region 12 is a region located on a surface of the lateral portion 11 on the vehicle front side, and extending in the vertical direction within a predetermined range. Thus, the front flange 34 and the front flange 44 may be joined above and below the flange 34c.

Further, as illustrated in FIG. 4, the flange 44c of the inner member 40 may be joined to a region 13 as a second region. The region 13 is a surface extending on an outer side of the dash panel 10 in the vehicle width direction, and on the vehicle rear side of the region 12. In the illustrated example, a side wall 14 extending toward the vehicle rear side is formed at an end of the lateral portion 11 on the outer side in the vehicle width direction, and the region 13 is provided on a surface of the side wall 14 on the outer side in the vehicle width direction. Thus, the flange 44c as the second joint may be joined to the dash panel 10 in the region 13 on the vehicle rear side of the region 12 of the dash panel 10, and to which the flange 34c is joined. In a state in which the dash panel 10, the outer member 30, and the inner member 40 are joined, the flange 44c may extend to an upper side of the flange 34c. In this state, the flange 44c may extend to a lower side of the flange 34c. That is, at least a part of the region 12 may be equal in height in the vertical direction to at least a part of the region 13.

Shapes of the dash panel 10, the outer member 30, and the inner member 40, and their joining relationships are not limited to the illustrated examples. For example, the shapes of the dash panel 10, the outer member 30, and the inner member 40, or their joining relationships may be set in accordance with shapes, dimensions, and positional relationships of the vehicle V, front wheels, front doors, or the like, as appropriate.

For example, the flange 34a may be formed by bending the front flange 34 toward the inner side in the vehicle width direction in the same manner as the flange 34c. In this case, the front flange 44 may be configured such that an edge of the flange 44a of the inner member 40 on the vehicle front side is located on the vehicle rear side of the surface of the lateral portion 11 on the vehicle front side in the same manner as the flange 44c. That is, the outer member 30 and the inner member 40 may be configured such that at least a part of the front flange 34 other than the flange 34c is joined to the front flange 44 of the inner member 40.

The flange 34a and the flange 34b may be formed by bending the front flange 34 toward the inner side in the vehicle width direction in the same manner as the flange 34c, and the flanges 34a, 34b, and 34c may be joined to the dash panel 10. In this case, the front flange 44 may be configured such that the edge of the flange 44a of the inner member 40 on the vehicle front side, and the edge of an flange 44b on the vehicle front side, are positioned behind the surface of the lateral portion 11 on the vehicle front side in the same manner as the flange 44c. That is, at least a part of the front flange 34 may be bent toward the inner side in the vehicle width direction to form the first joint joined to the dash panel 10.

By joining the outer member 30 and the inner member 40, a space is formed inside the front pillar 20. Therefore, in the cross-section view illustrated in FIG. 4, a closed cross section 5 is formed in the front pillar 20. The closed cross section 5 is a cross section defined by at least the outer member 30, the dash panel 10 or the inner member 40. As in the illustrated example, the closed cross section 5 may be defined by the outer member 30, the inner member 40, and an outer end of the dash panel 10 in the vehicle width direction.

As illustrated in FIG. 4, a reinforcing member 50 may be arranged in an inner space of the front pillar 20. The reinforcing member 50 illustrated in FIG. 4 has a substantially hat-shaped cross section that opens toward the inner side in the vehicle width direction at the lower pillar portion 21. Further, the reinforcing member 50 includes a front wall 51, a side wall 52, and a rear wall 53. The front wall 51 forms a portion of the reinforcing member 50 on the vehicle front side. The side wall portion 52 forms a portion of the reinforcing member 50 on the outer side in the vehicle width direction. The rear wall 53 forms a portion of the reinforcing member 50 on the vehicle rear side.

A front flange 54 may be formed on the vehicle front side of the front wall 51 so as to extend in the vertical direction. In the illustrated example, a flange 54c forming a part of the front flange 54 extends toward the inner side in the vehicle width direction from an end of the front wall 51 on the inner side in the vehicle width direction. The flange 54c may be disposed between the flange 34c of the outer member 30 and the lateral portion 11 of the dash panel 10. In the cross-sectional view illustrated in FIG. 4, the flange 34c, the flange 54c, and the dash panel 10 are joined using welding or other means. That is, the flange 34c and the dash panel 10 may be indirectly joined via the flange 54c.

The portion of the front flange 54 forming a portion above the flange 54c may be disposed between the flange 34a of the outer member 30 and the flange 44a of the inner member 40. A portion of the front flange 54 forming a lower portion below the flange 54c may be disposed between the flange 34b of the outer member 30 and the flange 44b of the inner member 40. The flanges 34a and 44a, and the flanges 34b and 44b may be indirectly joined via the front flange 54 using welding or other means.

A rear flange 55 may be formed on the rear wall 53 to extend in the vertical direction on the vehicle rear side. The rear flange 55 illustrated in the drawings is formed to extend toward the vehicle rear side from an end of the rear wall 53 on the inner side in the vehicle width direction. The rear flange 55 may extend along a portion of the front pillar 20 defining the vehicle front side of the front door opening 2. The rear flange 55 may be disposed between the rear flange 35 of the outer member 30 and the rear flange 45 of the inner member 40. The rear flange 35 and the rear flange 45 may be indirectly joined via the rear flange 55 using welding or other means.

Note that the reinforcing member 50 may not be arranged in an internal space of the front pillar 20. In this case, the flange 34c of the outer member 30 and the dash panel 10 may be directly joined to each other. The flanges 34a and 44a, the flanges 34b and 44b, and the rear flange 35 and the rear flange 45 may be directly joined to each other.

In the description above, the vehicle side structure according to the embodiment has been described by taking a left side of the vehicle V as an example, but the description is not limited thereto. For example, the vehicle side structure may be applied to a right side of the vehicle V. In this case, the vehicle left side and the vehicle right side may be symmetrical with respect to a plane parallel to the vertical direction of the vehicle including the centerline in the vehicle width direction in the plan view of the vehicle V.

The operation and effect of the vehicle side structure according to the embodiment will be described below.

(1) A vehicle side structure according to an embodiment includes the dash panel 10 of the vehicle V and the front pillar 20 joined to the dash panel 10 on an outer side in the vehicle width direction. The front pillar 20 includes the outer member 30 forming an outer side of the front pillar 20 in the vehicle width direction. At least a part of the first flange 34 formed on a front side of the outer member 30 in a vehicle longitudinal direction is bent toward the inner side in the vehicle width direction to form the first joint 34c joined to the dash panel 10.

According to the vehicle side structure according to the embodiment, at least a part of the front flange 34 of the outer member 30 is bent toward the inner side in the vehicle width direction to be joined to the dash panel 10. Therefore, the area of the closed cross section 5 can be set larger without excessively increasing a width D1 of the front pillar 20 in the vehicle longitudinal direction compared with a case in which, for example, the flange 34c extends from an end of the front wall 31 on the inner side in the vehicle width direction to be joined to the flange 44c. More specifically, in the cross-sectional view illustrated in FIG. 4, the front flange 34 is bent toward the inner side in the vehicle width direction in the same manner as the flange 34c, so that the extension toward the vehicle front side is suppressed. Therefore, without excessively increasing the width D1, the front wall 31 can be set at a further forward position of the vehicle. A dimension D2 of the cross section of the front pillar 20 in the vehicle longitudinal direction can be set to be larger. Thereby, the area of the closed cross section 5 can be set to be larger, and the rigidity of the front pillar 20 can be more reliably secured. Moreover, without increasing a thickness of a panel member constituting the front pillar 20, the sectional performance of the front pillar 20, such as the section modulus and the second moment of area, can be improved. That is, a sectional performance of the front pillar 20 can be improved without increasing weight. Therefore, according to the vehicle side structure according to this embodiment, the rigidity of the front pillar 20 can be sufficiently secured without excessively increasing the width D1 of the front pillar 20 in the vehicle longitudinal direction. The width D1 is a width of the front pillar 20 in the vehicle longitudinal direction, and in the example illustrated in FIG. 4, it is a distance in the vehicle longitudinal direction between a tip of the flange 34c and a tip of a rear flange. The dimension D2 is a dimension of the cross section of the front pillar 20 in the vehicle longitudinal direction, and in the example illustrated in FIG. 4, it is a distance in the vehicle longitudinal direction between an end of the front wall 31 on the inner side in the vehicle width direction and an end of the rear wall 33 on the inner side in the vehicle width direction.

(2) The first joint 34c may include the portion 34cl equal in height in the vertical direction to a part 22 of the outer member 30, to which the door hinge 4 of the vehicle V is attached.

Thereby, the area of the closed cross section 5 of the part of the outer member 30, on which the hinge attachment part 22 is provided can be set to be larger. Therefore, the rigidity of a part of the front pillar 20 to which a load of the front door 3 is applied can be more reliably secured.

(3) The front pillar 20 may include the inner member 40 forming an inner side of the front pillar 20 in the vehicle width direction. At least a part of the first flange 34 other than the first joint 34c may be joined to the second flange 44 formed on a front side of the inner member 40 in the vehicle longitudinal direction.

Thus, when the outer member 30 and the inner member 40 are joined to each other, the outer member 30 can be more easily positioned. Therefore, the vehicle side structure according to the embodiment can be more easily formed.

(4) The first flange 34 and the second flange 44 may be joined on an upper side and a lower side of the first joint 34c.

Thus, the front flange 34 and the front flange 44 are joined on an upper side and a lower side of the flange 34c. That is, the portions where the front flange 34 and the front flange 44 are joined to each other can be set at two locations. Therefore, when the outer member 30 and the inner member 40 are joined to each other, the outer member 30 can be more easily positioned. As a result, the vehicle side structure according to the embodiment can be more easily formed.

(5) The second flange 44 may include a second joint 44c in which the edge 44d on the vehicle front side is arranged on the vehicle rear side of the first joint 34c of the outer member 30. The second joint 44c is joined to the dash panel 10 in the second region 13 on the vehicle rear side of the first region 12 of the dash panel 10, to which the first joint 34c of the first flange 34 is joined, and at least a part of the first region 12 may be equal in height in the vertical direction to at least a part of the second region 13.

Thus, when the flange 34c is joined to the region 12, the number of members joined to the dash panel 10 can be reduced. For example, in the cross-sectional view illustrated in FIG. 4, the flange 44c of the inner member 40 is not disposed between the flange 34c and the dash panel 10. Therefore, when the flange 34c is joined to the region 12, the flange 34c, the flange 54c, and the lateral portion 11 may be joined using welding or other means. When the reinforcing member 50 is not arranged inside the front pillar 20, the flange 34c and the lateral portion 11 may be joined. By thus reducing the number of members joined to each other, the flange 34c and the dash panel 10 can be more reliably joined. Therefore, the vehicle side structure according to the embodiment can be more easily formed.

(6) The dash panel 10 may define the wheel house 1 of the vehicle V on a rear side in a vehicle longitudinal direction.

Thus, the portion of the inner periphery of the front door opening 2 on the vehicle front side can be set closer to the wheel house 1 while securing the rigidity of the front pillar 20. Therefore, the dimension of the front door opening 2 in the vehicle longitudinal direction can be set larger to provide the vehicle V that makes it easier to get in and get out of the vehicle.

### LIST OF REFERENCE NUMERALS

V vehicle
1 wheel house
4 door hinge
10 dash panel
12 region
13 region
20 front pillar
22 hinge mounting part (part)
30 outer member
34 front flange (first flange)
34 flange (first joint)
34c1 portion
40 inner member
44 front flange (second flange)
44c flange (second joint)
44d edge

1. A vehicle side structure comprising:
a dash panel of a vehicle; and
a front pillar joined to the dash panel an outer side in a vehicle width direction;
wherein:
the front pillar comprises an outer member forming an outer side of the front pillar in the vehicle width direction, and an inner member forming an inner side of the front pillar in the vehicle width direction;
at least a part of a first flange formed on a front side of the outer member in a vehicle longitudinal direction is bent toward an inner side in the vehicle width direction to form a first joint joined to the dash panel;
at least a part of the first flange other than the first joint is joined to a second flange formed on a front side of the inner member in the vehicle longitudinal direction and extending toward a front side in the vehicle longitudinal direction; and
a portion of the first flange equal in height in the vertical direction to the first joint is not joined to the second flange extending toward the front side in the vehicle longitudinal direction.

2. The vehicle side structure according to claim 1, wherein the first joint comprises a portion equal in height in the vertical direction to a part of the outer member, to which a door hinge of the vehicle is attached.

3. (canceled)

4. The vehicle side structure according to claim 1, wherein the first flange and the second flange are joined on an upper side and a lower side of the first joint.

5. The vehicle side structure according to claim 1, wherein:
the second flange comprises a second joint in which an edge on a vehicle front side is arranged on a vehicle rear side of the first joint of the outer member;
the second joint is joined to the dash panel in a second region on a vehicle rear side of a first region of the dash panel, to which the first joint of the first flange is joined; and
at least a part of the first region is equal in height in the vertical direction to at least a part of the second region.

6. The vehicle side structure according to claim 1, wherein the dash panel defines a wheel house of the vehicle on a rear side in the vehicle longitudinal direction.
